(19) United States
(12) Patent Application Publication
(10) Pub. No.: US 2022/0305335 A1
(43) Pub. Date: Sep. 29, 2022

(54) Golf Swing Analysis System

(71) Applicant: Techno Craft Corporation, Niigata-ken (JP)

(72) Inventor: Masanari Togasaka, Niigata (JP)

(73) Assignee: Techno Craft Corporation, Niigata-ken (JP)

(21) Appl. No.: 17/656,188

(22) Filed: Mar. 23, 2022

(30) Foreign Application Priority Data
Mar. 25, 2021 (JP) 2021-051224

(51) Int. Cl. A63B 24/00; A63B 71/06

(52) U.S. Cl. CPC A63B 24/0003; A63B 71/0622; A63B 24/0062; A63B 2071/0638; A63B 2220/803; A63B 2220/836; A63B 2225/50; A63B 2102/32

(57) ABSTRACT

A virtual play system is composed of a mobile terminal 2 worn by a player P, a virtual play display terminal 6 provided with a display unit 86, and a cloud server 4 capable of communicating with the mobile terminal 2 and the virtual play display terminal 6. The mobile terminal 2 includes a data analysis unit that transmits first measurement data obtained by measuring and quantifying an actual motion of player P during play and second measurement data obtained by measuring and quantifying the motion of player P during simulated play to the cloud server 4, and the cloud server 4 includes a virtual play data generation unit that calculates virtual play data based on the first measurement data and the second measurement data, and the virtual play display terminal 6 displays the virtual play data.

### CROSS-REFERENCE TO RELATED APPLICATION

This application claims priority to Japanese Patent Application No. 2021-051224 filed on Mar. 25, 2021, which is hereby incorporated herein by reference in its entirety.

### TECHNICAL FIELD

The present invention relates to a virtual play system such as sports.

### BACKGROUND

Conventionally, there is Japanese Patent No. 6938030 filed and registered by the applicant of the present application in Japan for a swing analysis system of a golf club in which speed and acceleration of wrist and waist when a golf player actually swings a golf club are measured using an acceleration measurement unit built into a wristwatch type terminal or a mobile terminal, on the other hand, flight distance of the ball hit by the player at the golf club is calculated by a flight distance calculation unit, and a relationship between the speed and acceleration of these wrist and waist and the flight distance of the ball is analyzed by an analysis unit built into the mobile terminal, which is hereby incorporated herein by reference in its entirety (Incorporation by Reference).

In the swing analysis system disclosed in the above patent document, every time the player swings the golf club during the actual round, speed and acceleration information of the wrist and waist, which is swing measurement data, is stored and accumulated in a storage unit, and the speed and acceleration information of the wrist and waist when a direction in which the ball is hit most analyzed by the analysis unit is controlled in the direction intended by the player and the flight distance is long can be displayed on the mobile terminal owned by the player as swing analysis data of a best shot.

### SUMMARY OF THE INVENTION

### Problem to be Solved by the Invention

The swing analysis system of the above patent document acquires swing measurement data when actually hitting a golf ball. In addition to this, it became even more necessary to think about a combination a virtual golf play in which simulated swing measurement data of a simulated swing performed indoors without a golf club is acquired and an expected flight distance of the ball is calculated based on the simulated swing measurement data.

Therefore, the present invention provides a virtual play system that calculates virtual play data based on actual play measurement data and simulated play measurement data as a result of further studies by the inventor.

### Means for Solving the Problem

The virtual play system according to the present invention comprises a player terminal worn by a player, a display terminal provided with a display unit, and a server device capable of communicating with the player terminal and the display terminal, wherein the player terminal includes a measurement data providing unit that transmits first measurement data obtained by measuring and quantifying motion of the player during actual play and second measurement data obtained by measuring and quantifying motion of the player during simulated play to the server device, and wherein the server device includes a virtual play data generation unit that calculates virtual play data based on the first measurement data and the second measurement data and the display terminal displays the virtual play data.

Further, in the virtual play system according to the present invention, the server device may be configured to be capable of communicating with the player terminal and the display terminal of a plurality of players, and the display terminal may be configured to be capable of displaying the virtual play data of the plurality of players.

Further, in the virtual play system according to the present invention, the first measurement data may be obtained by measuring and quantifying a swing motion when the player actually hits a ball with a golf club, the second measurement data may be obtained by measuring and quantifying a simulated swing motion performed by the player without holding the golf club, and the virtual play data may be trajectory data of the ball when it is assumed that the player holds the golf club and performs the same operation as the simulated swing operation to hit the ball.

### Advantageous Effects of the Invention

According to the virtual play system according to the present invention, virtual play data can be calculated based on the actual play measurement data and the simulated play measurement data.

### BRIEF DESCRIPTION OF THE DRAWINGS

FIG. 1 is an explanatory diagram showing an outline of a virtual play system according to an embodiment of the present invention.

FIG. 2 is a schematic configuration diagram around a player performing a swing motion in the present embodiment.

FIG. 3 is a plan view of a wristwatch type terminal in the present embodiment.

FIG. 4 is a block diagram showing an electrical configuration of the wristwatch type terminal in the present embodiment.

FIG. 5 is a diagram showing position information of a golf course in the present embodiment.

FIG. 6 (a) is a diagram showing a height difference when a shot is launched in the present embodiment, FIG. 6 (b) is a diagram showing a height difference when a shot is downhill in the present embodiment, and FIG. 6 (c) is a diagram showing a height difference when a shot is horizontal in the present embodiment.

FIG. 7 is a block diagram showing an electrical configuration of a six-axis sensor unit in the present embodiment.

FIG. 8 is a block diagram showing an electrical configuration of a mobile terminal.

FIG. 9 is a flowchart showing an example of data synchronization procedure.

FIG. 10 is a block diagram showing an electrical configuration of a cloud server.

### MODE FOR CARRYING OUT THE INVENTION

Preferred embodiments of the present invention will be described with reference to the accompanying drawings. The embodiments described below do not limit the content of the present invention described in the claims. Moreover, not all of the configurations described below are essential requirements of the present invention.

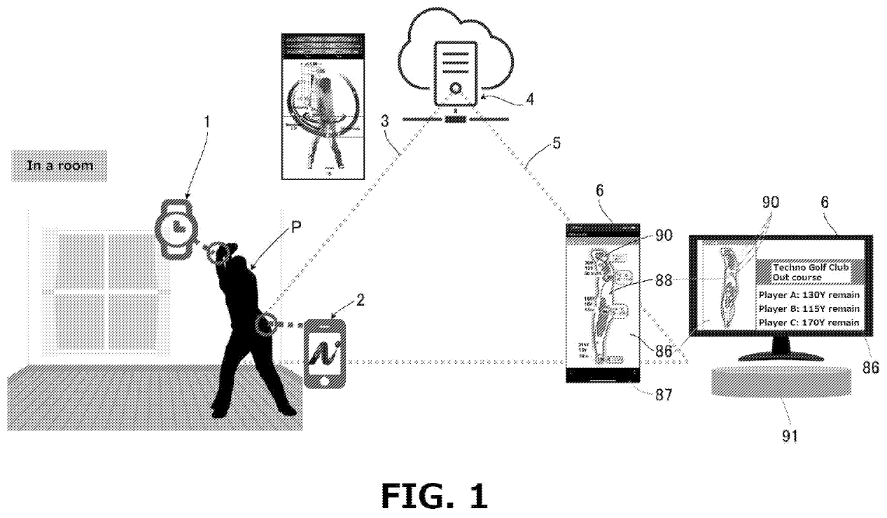

FIG. 1 is a diagram showing an outline of a system configuration relating to a virtual play system of the present embodiment. In the figure, the virtual play system mainly includes a wristwatch type terminal 1 and a mobile terminal 2 worn by a player P during a simulated play in a room or the like while being worn by the player P during an actual round at a golf course, a cloud server 4 that enables exchange of various data with the mobile terminal 2 via the communication means 3 and a virtual play display terminal 6 such as a PC (personal computer) and mobile terminal that allows player P to input operations and view displays during simulated play and to exchange various data with the cloud server 4 via the communication means 5. In the present embodiment, the measured object to be measured by the virtual play system is the golf player P, but it may be a player in various sports competitions other than golf. The functions of the virtual play system shown in FIG. 1 will be described in detail later together with an operation explanation.

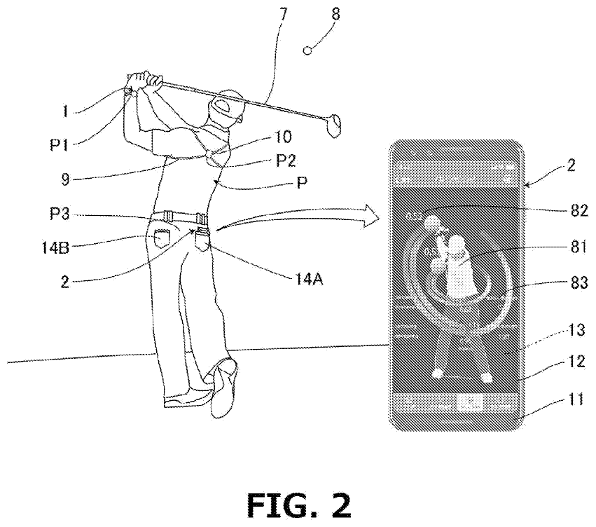

FIG. 2 shows the main configuration of the virtual play system, especially around the player P. In the figure, as is well known, golf is a kind of sports in which the player P performs a swing motion of a golf club (hereinafter, the swing motion when the ball 8 is actually hit by the golf club 7 at the golf course is simply referred to as “swing motion”, and the swing motion during simulated play without the golf club 7 is referred to as “simulated swing motion”.) on a golf course to hit a stationary ball 8 and competes for how few strokes can be put into a hole called a hole (not shown). Here, a wristwatch type terminal 1 serving as a terminal (wearable watch) is attached to, for example, the left wrist P1 in which the player P transmits a swing force to the golf club 7, and as another terminal, the mobile terminal 2 is housed in a pocket, preferably a rear pocket, which is a storage part for a lower body clothes of the player P. Further, at an intermediate position between the left and right shoulder blades on the back P2 of the player P, for example, a six-axis sensor unit 10 having an outer box shape is mounted by using a string-shaped strap 9 hung on the back P2.

The wristwatch type terminal 1 may be attached to an arm of the player P, preferably the wrist. In the present embodiment, as shown in FIG. 2, the wristwatch type terminal 1 is attached to the left wrist P1 of the right-handed player P. The wristwatch type terminal 1 may be used by the left-handed player P, and the wristwatch type terminal 1 may be attached to the right wrist.

The mobile terminal 2 owned by the player P has a function of a general smartphone and a display unit 12 for displaying a screen and an operation unit 13 for manual operation are provided on a front surface of a flat body 11. In the present embodiment, the mobile terminal 2 is housed in a right rear pocket 14A of the lower body clothing, but the mobile terminal 2 may be housed in a left rear pocket 14B as long as it is close to the waist P3 in order to measure acceleration of the waist P3 of the player P.

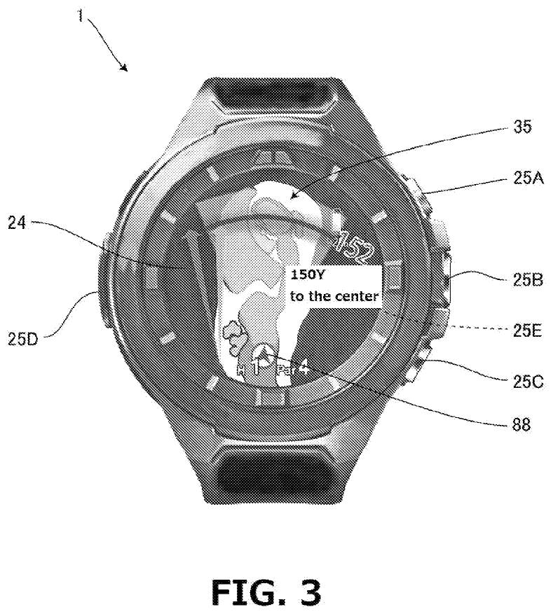

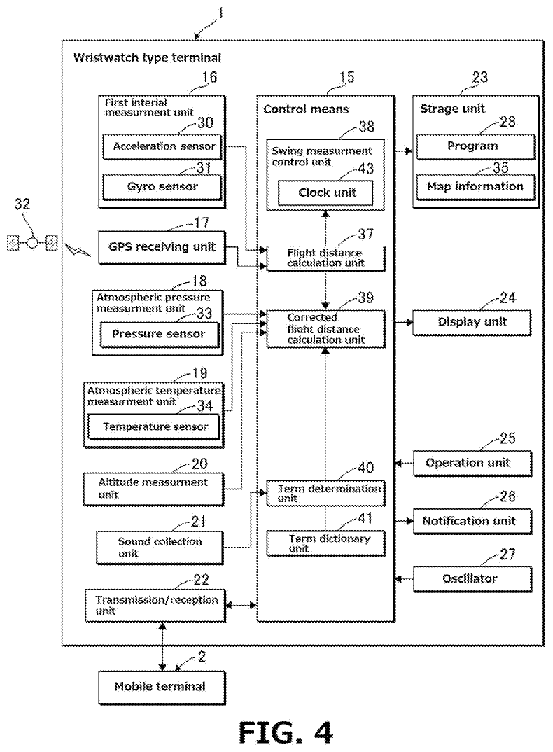

FIG. 3 shows an appearance of the wristwatch type terminal 1 and FIG. 4 shows a main electrical configuration of the wristwatch type terminal 1. In each of these figures, the wristwatch type terminal 1 includes a control means 15, a first inertial measurement unit 16, a GPS (Global Positioning System) receiving unit 17, an atmospheric pressure measurement unit 18, a temperature measurement unit 19, an altitude measurement unit 20, a sound collection unit 21, a transmission/reception unit 22, a storage unit 23, a display unit 24, an operation unit 25, a notification unit 26, and an oscillator 27.

The control means 15 includes a CPU (Central Processing Unit) and controls the entire wristwatch type terminal 1 based on a program 28 stored in the storage unit 23. When the CPU executes arithmetic processing according to the program 28, each function of the wristwatch type terminal 1 is realized. The program 28 includes a flight distance correction program for correcting a flight distance of the ball 8 hit by the player P by performing the swing motion of the golf club 7, waveform data of acceleration and angular velocity of the left wrist P1 when player P performs the swing motion of the golf club 7, a play data transmission program for sending the waveform data of the acceleration and the angular velocity of the left wrist P1 when the player P performs the simulated swing motion to the mobile terminal 2 which is the measurement means of the virtual play system and the like.

The first inertial measurement unit 16 incorporates an acceleration sensor 30 and a gyro sensor 31, both of which are inertial sensors, as detection means for detecting the motion of the player P. The acceleration sensor 30 can measure the acceleration in an orthogonal triaxial direction on the left wrist P1 of the player P and the gyro sensor 31 can measure the angular velocity around each of the three orthogonal axes on the left wrist P1 of the player P. The first inertial measurement unit 16 measures the acceleration and the angular velocity of the left wrist P1 during a series of the swing motions of the player P wearing the wristwatch type terminal 1. Acceleration information and angular velocity information measured by the first inertial measurement unit 16 are sent to the control means 15 as the acceleration waveform and the angular velocity waveform of the left wrist P1 during the swing motion of the player P.

The first inertial measurement unit 16 measures the acceleration and the angular velocity of the left wrist P1 during the simulated swing motion of the player P wearing the wristwatch type terminal 1 during the simulated play. Then, the acceleration information and the angular velocity information at the time of the simulated swing motion measured by the first inertial measurement unit 16 are transmitted to the control means 15 as the acceleration data and the angular velocity data of the left wrist P1 at the time of the simulated swing motion of the player P and are transmitted to the mobile terminal 2 via the transmission/reception unit 22.

The GPS receiving unit 17 constitutes a position measuring unit that acquires a current position of the wristwatch type terminal 1 and wirelessly receives radio waves from a plurality of artificial satellites 32 to measure a three-dimensional position (longitude, latitude and altitude) of the wristwatch type terminal 1 and thus the player P wearing the wristwatch type terminal 1 and send a position information to the control means 15. A position detecting device other than the GPS receiving unit 17 may be used as long as it can detect the current position of the wristwatch type terminal 1. In addition, an atomic clock is mounted on the artificial satellite 32. An extremely accurate time signal wave is transmitted from the artificial satellite 32 at a specific frequency, and a time axis of the wristwatch type terminal 1 is defined by receiving this by the GPS receiving unit 17. The GPS receiving unit 17 and the artificial satellite 32 function as the position measuring unit.

The atmospheric pressure measuring unit 18 incorporates a pressure sensor 33 and measures atmospheric pressure using the pressure sensor 33. Measured atmospheric pressure information is sent to the control means 15.

The temperature measuring unit 19 incorporates a temperature sensor 34 using a thermistor (not shown), and measures atmospheric temperature by the temperature sensor 34. Measured atmospheric temperature information is sent to the control means 15.

The altitude measurement unit 20 calculates height above sea level (altitude) (hereinafter, referred to as “altitude”) at the current position based on the amount of change in the atmospheric pressure measured by the pressure sensor 33 using the pressure sensor 33 incorporated in the atmospheric pressure measurement unit 18 and sends altitude information of the current position to the control means 15. The altitude measurement unit 20 converts change in the atmospheric pressure to calculate the relative altitude, and when the atmospheric pressure changes due to meteorological conditions, the altitude of the measured value also changes. Therefore, more accurate altitude can be measured by adjusting the altitude of the altitude measuring unit 20 at a place where the accurate altitude can be known. For example, by adjusting the altitude at a place in the golf course where the exact altitude can be known before the round, it is possible to measure the altitude more accurately during the subsequent play. As the altitude at the current position of the player P, the altitude of the three-dimensional position (longitude, latitude and altitude) of the player P received by the GPS receiving unit 17 may be used.

The sound collection unit 21 collects external sounds and sends them as voice information to the control means 15, and the sound collection unit 21 is, for example, a microphone. The sound collection unit 21 of the present embodiment is assumed to collect the sound of the player P, and it is sufficient that the human voice can be collected. The sound collection unit 21 functions as a state input unit when a state of the shot point, which will be described later, is input by voice. Further, the sound collection unit 21 functions as a first instruction input unit when the first inertial measurement unit 16 gives a voice instruction to start and end the measurement of acceleration.

The transmission/reception unit 22 enables bidirectional communication with another device, for example, the mobile terminal 2 via a wireless communication means. Therefore, the wristwatch type terminal 1 can send and receive various information to and from the mobile terminal 2 and the like.

The storage unit 23 is configured by using various storage devices such as a magnetic hard disk device and a semiconductor storage device and can write and read various information such as actual play data and simulated play data including the acceleration information and the angular velocity information measured by the first inertial measurement unit 16, the position information of the wristwatch type terminal 1 received by the GPS receiving unit 17, the atmospheric pressure information measured by the atmospheric pressure measuring unit 18, the temperature information measured by the temperature measurement unit 19, the altitude information measured by the altitude measurement unit 20 and the audio information input from the sound collection unit 21. Further, map information 35 of the golf course is stored in advance in the storage unit 23. The map information 35 is a two-dimensional map or a three-dimensional map including position coordinate information, and can be changed, added, deleted, or updated.

The display unit 24 receives a display control signal from the control means 15 and performs various displays such as the current position of the wristwatch type terminal 1. As shown in FIG. 3, the display unit 24 is composed of a liquid crystal module and a liquid crystal panel exposed on a front surface of a main body of the wristwatch type terminal 1 and as is well known, these liquid crystal module and liquid crystal panel display a large number of sub-pixels in a dot matrix arranged in a grid pattern. The display unit 24 functions as an information presentation unit when displaying and presenting advice information described later by characters, a map, or the like.

The operation unit 25 receives an operation by the player P and sends an electrical operation signal to the control means 15. As shown in FIG. 3, the operation unit 25 includes a first button 25A, a second button 25B, a third button 25C and a fourth button 25D. Further, the display unit 24 is a touch panel 25E and a surface portion thereof also functions as the operation portion 25. The number of buttons as the operation unit 25 is not limited to four and can be increased or decreased. The operation unit 25 functions as a state input unit when inputting the state of the shot point described later. Further, the operation unit 25 functions as a second instruction input unit when the first inertial measurement unit 16 instructs the start and end of the acceleration measurement by voice. The first instruction input unit by the sound collection unit 21 and the second instruction input unit by the operation unit 25 may be provided with at least one of them.

The notification unit 26 notifies the player P of the information and the like stored in the storage unit 23 by voice, and is, for example, a speaker. The notification unit 26 functions as an information presentation unit when presenting the advice information described later by voice. Further, the notification unit 26 functions as an output unit when presenting swing information at the best flight distance, which will be described later, by voice or vibration. The output unit in this case is composed of, for example, a speaker that outputs sound and/or a vibrator that generates vibration.

The oscillator 27 sends a clock signal generated at a predetermined cycle to the control means 15, and is composed of, for example, a silicon oscillator, a ceramic oscillator, a crystal oscillator, or the like. Further, by forming the silicon oscillator to be an oscillation circuit on the same silicon chip as the control means 15 to be a microcomputer, the oscillator 27 can be incorporated in an extremely small size and at low cost.

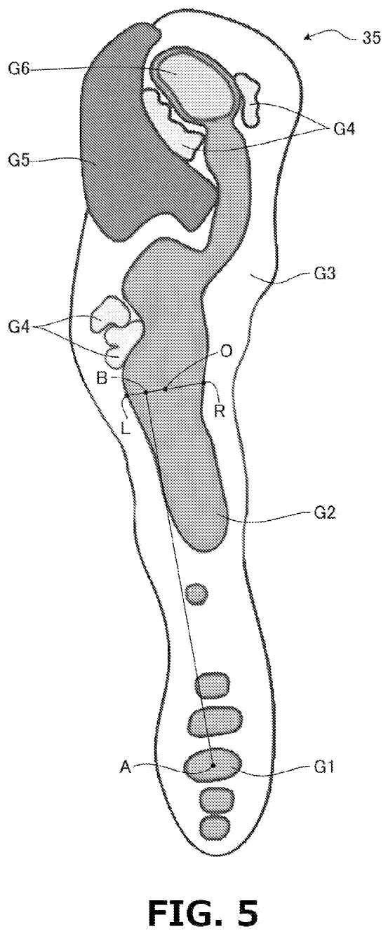

The control means 15 includes a flight distance calculation unit 37 that calculates the actual flight distance of the ball 8 hit against a head of the golf club 7 when the player P performs the swing motion of the golf club 7. Explaining a specific method of calculating the flight distance with reference to FIG. 5, the first inertial measurement unit 16 included in the wristwatch type terminal 1 receives an instruction from the sound collection unit 21 and the operation unit 25 to start measurement and then starts the measurement the acceleration and the angular velocity of the wrist P1 equipped with the wristwatch type terminal 1, and the first inertial measurement unit 16 receives an instruction from the sound collection unit 21 and the operation unit 25 to end the measurement and then ends the measurement of the acceleration and the angular velocity. During this period, when the change in the acceleration and the angular velocity corresponding to the case where the player P wearing the wristwatch type terminal 1 swings is measured, the flight distance calculation unit 37 receives the measurement result from the first inertial measurement unit 16 and determines that the player P has swung the golf club 7 and acquires the position information of the swing position A of the player P by the GPS receiving unit 17. The flight distance calculation unit 37 determines that the last swing at the acquired position A is a first shot in which the player P hits the ball 8 and stores the position information in the storage unit 23. Further, the flight distance calculation unit 37 associates the measurement result from the measurement start to the measurement end by the first inertial measurement unit 16 with the position information of position A and transfers the measurement result to a swing measurement control unit 38 described later, which is also incorporated in the control means 15, as the waveform of the acceleration and the angular velocity during a series of the swing motions at position A.

Next, the player P moves to an arrival point of the hit ball 8. When, at that position B, the flight distance calculation unit 37 determines that the player P has swung the golf club 7 between the measurement start and the measurement end of the acceleration and the angular velocity by the first inertial measurement unit 16, as in the position A, the flight distance calculation unit 37 acquires the position information of the swing position B by the GPS receiving unit 17. The flight distance calculation unit 37 determines that the last swing at the acquired position B is a second shot in which the player P hits the ball 8 and stores the position information in the storage unit 23. Further, the flight distance calculation unit 37 associates the measurement result from the measurement start to the measurement end by the first inertial measurement unit 16 with the position information of position B and transfers the measurement result to the swing measurement control unit 38 described later, which is also incorporated in the control means 15, as the waveform of the acceleration and the angular velocity during a series of the swing motions at position B.

Then, the flight distance calculation unit 37 reads the position information of the first shot and the position information of the second shot from the storage unit 23 and calculates the linear distance between the position A and the position B. The calculated linear distance is stored in the storage unit 23 as the flight distance of the first shot from the position A in association with each waveform of the acceleration and the angular velocity during the swing motion at the position A described above. In the same manner thereafter, the position information of a third shot, a fourth shot, and so on are acquired, the flight distances of the second shot from the position B, the third shot from the position C, and so on are calculated, respectively, and in association with the waveforms of the acceleration and the angular velocity at the time of the swing motion at the position B, the position C, and so on, these are stored in the storage unit 23 as the flight distance information. In the present embodiment, the last swing at the position A is determined to be the first shot in which the player P hits the ball 8, but by declaring that the player P will shoot with a voice and then shooting, the sound is collected by the sound collection unit 21 and the position information of the position A at the time of collecting sound may be acquired by the GPS receiving unit 17. Further, the player P may operate the operation unit 25 and acquire the position information of the position A by the GPS receiving unit 17.

Further, the flight distance calculation unit 37 calculates whether or not the ball 8 hit by the player P is displaced in a left-right direction from a center position O of a fairway. Explaining the specific calculation method for the first shot, as shown in FIG. 5, the position information of a left end position L and a right end position R, which are intersections of a straight line perpendicular to a straight line connecting the positions A and B and both ends of the fairway G2, is read from the map information 35. Then, a midpoint of the straight line connecting the left end position L and the right end position R is determined as the center position O of the fairway G2. When the position B is separated from the center position O in the left direction by a predetermined distance (for example, 2 m) or more, it is determined that the first shot is shifted to the left. When the position B is separated from the center position O in the right direction by a predetermined distance (similar to the left direction, for example, 2 m), it is determined that the first shot is shifted to the right. When the position B is less than a predetermined distance from the center position O, it is determined that the first shot is not displaced. The determination of the deviation in the left-right direction is also performed for the subsequent second shot, third shot, and so on. The predetermined distance for determining the deviation in the left-right direction can be set arbitrarily and instead of the center position O calculated by the flight distance calculation unit 37, the deviation in the left-right direction from the direction intended by the player P may be determined. An intended direction of the player P is stored and set in the storage unit 23, for example, by input from the operation unit 25 by the player P. Alternatively, the storage may be set in the storage unit 23 in advance. The determination result of the deviation in the left-right direction is associated with number information of the golf club 7, and these are stored in the storage unit 23 as the flight distance information. When a plurality of determination results are accumulated, the flight distance calculation unit 37 calculates the ratio of deviation to the left, the ratio of deviation to the right, and the ratio of no deviation, and stores these in the storage unit 23 as flight distance information.

In the above example, the flight distance calculation unit 37 calculates the deviation of the position B from the center position O of the fairway G2 of the course for the ball 8 hit by the player P. However, there are quite a few cases where the player P intentionally hits the ball 8 to the left side or the right side depending on the course, so as another example, an arbitrary point on a straight line connecting the left end position L and the right end position R may be determined as a reference position, and the deviation of the position B from the reference position may be calculated by the flight distance calculation unit 37. The reference position is determined, for example, by the player P operating the operation unit 25 and instructing in which direction the ball 8 was intended to be hit. In this case, for example, if the intention is to hit the ball 8 in the direction of the center of the fairway G2, the above-mentioned center position O is determined as the reference position by instructing the operation unit 25 to that effect.

As shown in FIG. 4, the control means 15 includes a corrected flight distance calculation unit 39 that calculates the corrected flight distance considering the altitude, temperature, atmospheric pressure, and the state of the shot point from the actual flight distance of the ball 8 hit by the player P. Here, the calculation method of the corrected flight distance calculation unit 39 in consideration of the influence of altitude will be described with respect to the corrected flight distance of the above-mentioned first shot flight distance. The altitude measurement unit 20 measures the altitude at the position A and sends the measured altitude information to the corrected flight distance calculation unit 39 of the control means 15. The corrected flight distance calculation unit 39 calculates the height difference between the altitude of the position A and the reference altitude of 0 m above sea level and calculates the corrected flight distance when it is assumed that the shot is taken at 0 m above sea level from the actual flight distance based on the altitude difference. In the present embodiment, the reference altitude is set to 0 m above sea level to calculate the corrected flight distance, but this reference altitude can be set arbitrarily.

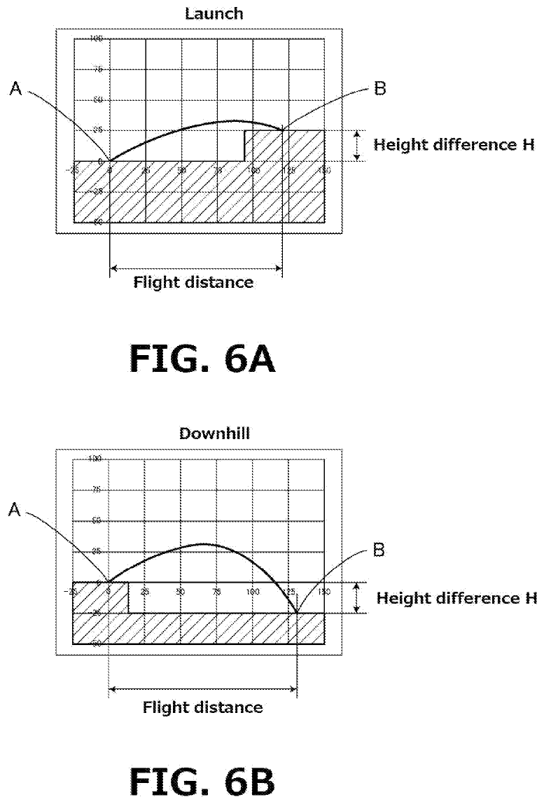

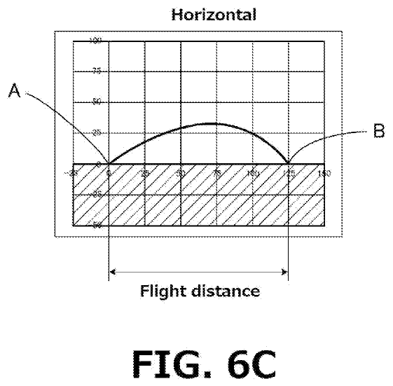

Further, the altitude measurement unit 20 measures the altitude even at the position B and sends the measured altitude information to the corrected flight distance calculation unit 39 of the control means 15. The corrected flight distance calculation unit 39 compares the altitude of the position A and the altitude of the position B, and if there is a difference in altitude, the height difference H is calculated. Then, when the position A is lower than the position B as shown in FIG. 6 (a), it is determined that the shot is a launch. Further, when the position A is higher than the position B as shown in FIG. 6 (b), it is determined that the shot is downhill. Furthermore, when there is no difference in altitude between the position A and the position B as shown in FIG. 6 (c), it is determined to be horizontal. Then, in the case of launch or downhill, the corrected flight distance assuming that there is no height difference H between the position A and the position B is calculated from the actual flight distance based on the height difference H. When it is determined to be horizontal, the actual flight distance is used as the corrected flight distance.

Next, the calculation method of the corrected flight distance calculation unit 39 in consideration of the influence of the temperature will be described with respect to the corrected flight distance of the above-mentioned first shot. The atmospheric temperature measurement unit 19 measures the atmospheric temperature at the position A and sends the measured atmospheric temperature information to the corrected flight distance calculation unit 39 of the control means 15. The corrected flight distance calculation unit 39 calculates the temperature difference between the atmospheric temperature at position A and the reference temperature of 20 degrees Celsius, and based on the temperature difference, the corrected flight distance is calculated from the actual flight distance when it is assumed that the shot is taken at 20 degrees Celsius by a predetermined calculation formula. In the present embodiment, the reference temperature is set to 20 degrees Celsius to calculate the corrected flight distance, but the reference temperature can be arbitrarily set.

Next, the calculation method of the corrected flight distance calculation unit 39 in consideration of the influence of the atmospheric pressure will be described with respect to the corrected flight distance of the above-mentioned first shot flight distance. The atmospheric pressure measurement unit 18 measures the atmospheric pressure at the position A and sends the measured atmospheric pressure information to the corrected flight distance calculation unit 39 of the control means 15. The corrected flight distance calculation unit 39 calculates the atmospheric pressure difference between the atmospheric pressure at position A and the reference atmospheric pressure of 1013 hectopascals, and based on the pressure difference, the corrected flight distance is calculated from the actual flight distance when it is assumed that the shot is made in 1013 hectopascals by a predetermined formula. In the present embodiment, the reference pressure is set to 1013 hectopascals to calculate the corrected flight distance, but this reference pressure can be set arbitrarily.

Next, the calculation method of the corrected flight distance calculation unit 39 in consideration of the influence of the situation of the shot point will be described with respect to the corrected flight distance of the above-mentioned first shot flight distance. In the present embodiment, the situation of the shot point is the state of the ground on which the ball 8 hit by the player P is placed on the golf course, and the strength and direction of the wind at the time of the shot. The ground conditions are tee ground G1, fairway G2, rough G3, bunker G4, pond G5, uphill slope and downhill slope and the wind strength at the time of shot is “strong” and “weak”, and the wind direction is “against”, “follow” and “crosswind”. The corrected flight distance may be calculated in consideration of other environmental conditions that affect the flight distance of the ball 8.

As shown in FIG. 4, the control means 15 includes a term determination unit 40 for determining the voice information transmitted from the sound collection unit 21. Further, the control means 15 includes a term dictionary unit 41 for storing pre-registered terms. The term registered in advance represents the state of a shot point such as “tee ground”, “fairway”, “rough”, “bunker”, “pond”, “uphill slope”, “downhill slope”, “against”, “follow”, and “crosswind”. Upon receiving the voice information from the sound collection unit 21, the term determination unit 40 determines whether or not the term related to the voice information is the term stored in the term dictionary unit 41. When the term related to the voice information is the term stored in the term dictionary unit 41, the term determination unit 40 sends a term signal corresponding to the term to the corrected flight distance calculation unit 39. When the corrected flight distance calculation unit 39 receives the term signal, the corrected flight distance calculation unit 39 calculates the corrected flight distance from the actual flight distance by using a predetermined calculation formula corresponding to the term, assuming that the shot point is the fairway G2 from the actual flight distance, there is no slope, and there is no wind. In the present embodiment, the corrected flight distance is calculated when the reference state of the shot point is the fairway G2, there is no inclination, and there is no wind, but this reference state can be arbitrarily set.

In the term dictionary unit 41, the terms corresponding to the number of the golf club 7 are stored in advance, and by inputting the golf club 7 number by voice before making a shot, the golf club 7 number information corresponding to the term (golf club 7 number) is sent from the term determination unit 40 to the corrected flight distance calculation unit 39. Therefore, the flight distance calculation unit 37 sends the actual flight distance information as the flight distance data to the storage unit 23 in correspondence with the number of the golf club 7. Similarly, the corrected flight distance calculation unit 39 also associates the calculated corrected flight distance with the number of the golf club 7 and sends the corrected flight distance information to the storage unit 23 as the corrected flight distance data. The storage unit 23 that has received the flight distance information and the corrected flight distance information stores the corrected flight distance information in association with the flight distance information and the acceleration waveform of the swing waveform for each hit, in correspondence with the number of the golf club 7. The terms stored in the term dictionary unit 41 can be added, deleted, changed, or updated.

In this embodiment, the method of inputting the state of the shot point and the number of the golf club 7 by voice is adopted, but the operation unit 25 may be operated to input the state of the shot point and the number of the golf club 7.

Further, in the present embodiment, the altitude, the atmospheric temperature, and the atmospheric pressure are all measured, and the state of the shot point is input. However, the items to be measured and the items to be input may be arbitrarily determined, for example, such as not measuring the atmospheric temperature, and items other than these may be added.

The control means 15 includes the swing measurement control unit 38 in which the waveform data of the acceleration and the angular velocity from the first inertial measurement unit 16 are taken in at intervals determined by the clock signal from the oscillator 27 and the motion of the left wrist P1 during the swing of the player P and the simulated swing is measured. The swing measurement control unit 38 has a function that upon receiving the waveform data of the acceleration and the angular velocity from the first inertial measurement unit 16 via the flight distance calculation unit 37 described above, stores the actual play data and the simulated play data in which the time information from a clock unit 43 is added to the waveform data in the storage unit 23 and after one or all the plays (swings) are completed, transfers the actual play data and the simulated play data stored in the storage unit 23 from the transmission/reception unit 22 of the wristwatch type terminal 1 to the mobile terminal 2 when the operation for instructing synchronization of the actual play data and the simulated play data is performed from the operation unit 13 of the mobile terminal 2.

The clock unit 43 provided in the control means 15 counts the time as the wristwatch type terminal 1 based on the clock signal from the oscillator 27 and here, the clock unit 43 adds a set fixed time interval regardless of, for example, the start time of the waveform data, the start and end times of the waveform data, and the start and end of the waveform data as the time information to be added to the waveform data of the acceleration and the angular velocity from the first inertial measurement unit 16. Alternatively, the time counted by the clock unit 43 may be added each time the waveform data of the acceleration or the angular velocity is acquired from the first inertial measurement unit 16. The clock unit 43 here is provided in the first inertial measurement unit 16 as a first clock unit for counting the time in the first inertial measurement unit 16 of the wristwatch type terminal 1.

Further, the swing measurement control unit 38 has a function of returning and transmitting the latest time counted by the clock unit 43 from the transmission/reception unit 22 to the mobile terminal 2 when a clock inquiry signal is transmitted from the operation unit 13 of the mobile terminal 2 and the signal is received by the transmission/reception unit 22. The clock inquiry signal from the mobile terminal 2 may be sent, for example, when the operation for instructing synchronization of the actual play data and the simulated play data described above is performed in order to simplify the operation and may be sent at another timing with some operation.

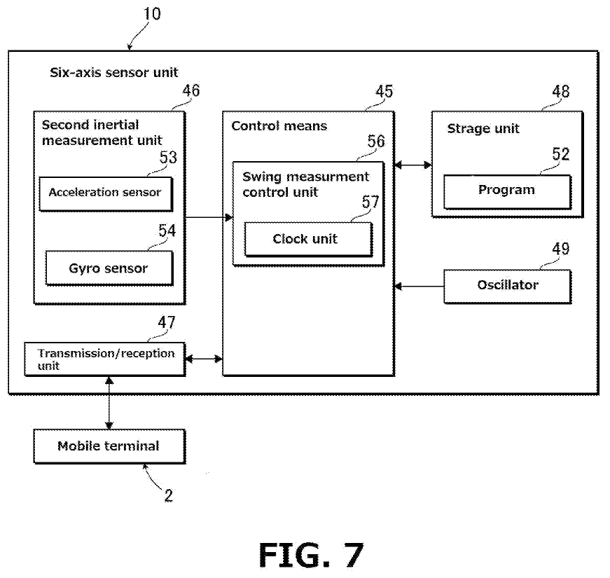

FIG. 7 shows an electrical configuration of the six-axis sensor unit 10. In the figure, the six-axis sensor unit 10 includes a control means 45, a second inertial measurement unit 46, a transmission/reception unit 47, a storage unit 48 and an oscillator 49.

The control means 45 includes a CPU (Central Processing Unit) and controls the entire the six-axis sensor unit 10 based on a program 52 stored in the storage unit 48. When the CPU executes arithmetic processing according to the program 52, each function of the six-axis sensor unit 10 is realized.

The second inertial measurement unit 46 incorporates an acceleration sensor 53 and a gyro sensor 54, both of which are inertial sensors, as detection means for detecting the motion of the player P. The acceleration sensor 53 can measure the acceleration in an orthogonal triaxial direction and the gyro sensor 31 can measure the angular velocity around each of the three orthogonal axes. The second inertial measurement unit 46 measures the acceleration and the angular velocity of the back P2 of the player P by the player P performing the swing operation with the six-axis sensor unit 10 attached to the back P2 by the strap 9. The acceleration information and the angular velocity information measured by the second inertial measurement unit 46 are sent to a swing measurement control unit 56 of the control means 45 as the acceleration waveform and the angular velocity waveform of the back P2 during the swing operation of the player P.

The transmission/reception unit 47 enables bidirectional communication between the mobile terminal 2 and the six-axis sensor unit 10 via a wired or wireless short-range communication means.

The storage unit 48 is configured by using various storage devices such as a magnetic hard disk device and a semiconductor storage device and can write and read various information such as the play data including the acceleration information and the angular velocity information measured by the second inertial measurement unit 46.

The oscillator 49 sends a clock signal generated at a predetermined cycle to the control means 45, and is composed of, for example, a silicon oscillator, a ceramic oscillator, a crystal oscillator, or the like. Further, by forming the silicon oscillator to be an oscillation circuit on the same silicon chip as the control means 45 to be a microcomputer, the oscillator 49 can be incorporated in an extremely small size and at low cost.

The control means 45 includes the swing measurement control unit 56 in which the waveform data of the acceleration and the angular velocity from the second inertial measurement unit 46 are taken in at intervals determined by the clock signal from the oscillator 49 and the motion of the back P2 during the swing of the player P is measured. The swing measurement control unit 56 has a function that upon receiving the waveform data of the acceleration and the angular velocity from the second inertial measurement unit 46, stores the actual play data in which the time information from a clock unit 57 is added to the waveform data in the storage unit 48 and after one or all the plays (swings) are completed, transfers the actual play data stored in the storage unit 48 from the transmission/reception unit 47 of the six-axis sensor unit 10 to the mobile terminal 2 when the operation for instructing synchronization of the actual play data is performed from the operation unit 13 of the mobile terminal 2. The clock unit 57 provided in the control means 45 counts the time as the six-axis sensor unit 10 based on the clock signal from the oscillator 49 and here, the clock unit 57 adds a set fixed time interval regardless of, for example, the start time of the waveform data, the start and end times of the waveform data, and the start and end of the waveform data as the time information to be added to the waveform data of the acceleration and the angular velocity from the second inertial measurement unit 46. Alternatively, the time counted by the clock unit 57 may be added each time the waveform data of the acceleration or the angular velocity is acquired from the second inertial measurement unit 46. The clock unit 57 here is provided in the second inertial measurement unit 46 as a first clock unit for counting the time in the second inertial measurement unit 46 of the six-axis sensor unit 10.

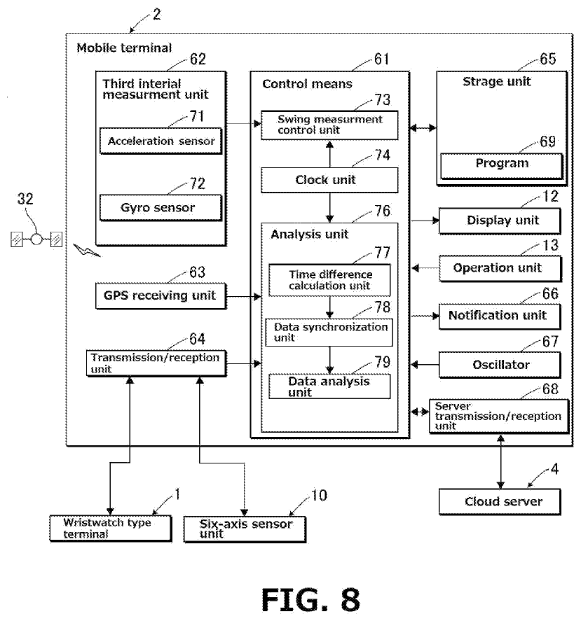

FIG. 8 shows an electrical configuration of the mobile terminal 2. In the figure, the mobile terminal 2 includes a control means 61, a third inertial measurement unit 62, a GPS (Global Positioning System) receiving unit 63, a transmission/reception unit 64, a storage unit 65, a notification unit 66, an oscillator 67, and a server transmission/reception unit 68 in addition to the display unit 12 and the operation unit 13 described above.

The control means 61 includes a CPU (Central Processing Unit) and controls the entire mobile terminal 2 based on the program 69 stored in the storage unit 65. When the CPU executes arithmetic processing according to the program 69, each function of the mobile terminal 2 is realized. Further, as described above, the program 28 realizes each function of the wristwatch type terminal 1 and the program 52 realizes each function of the 6-axis sensor unit 10. These programs 28, 52 and 69 correspond to swing analysis programs for analyzing the swing motion of the player P, and these programs 28, 52 and 69 are executed by the control means 15, 45, 61 as a computer incorporated in the wristwatch type terminal 1, the 6-axis sensor unit 10, and the mobile terminal 2, respectively. As a result, the swing analysis system in the virtual play system is realized.

The third inertial measurement unit 62 incorporates an acceleration sensor 71 and a gyro sensor 72, both of which are inertial sensors, as detection means for detecting the motion of the player P. The acceleration sensor 71 can measure the acceleration in an orthogonal triaxial direction and the gyro sensor 72 can measure the angular velocity around each of the three orthogonal axes. The third inertial measurement unit 62 measures the acceleration and the angular velocity of the waist P3 of the player P by the player P performing the swing operation in a state where the mobile terminal 2 is housed in the right rear pocket 14A. The acceleration information and the angular velocity information measured by the third inertial measurement unit 62 are sent to a swing measurement control unit 73 of the control means 61 as the acceleration waveform and the angular velocity waveform of the left waist P3 during the swing operation of the player P.

The third inertial measurement unit 62 measures the acceleration and angular velocity of the waist P3 of the player P by performing the simulated swing motion in the state where the mobile terminal 2 is housed in the right rear pocket 14A during the simulated play. Then, the acceleration information and the angular velocity information at the time of the simulated swing motion measured by the third inertia measuring unit 62 are sent to the swing measurement control unit 73 of the control means 61 as the acceleration data and the angular velocity data of the left waist P3 during the simulated swing motion of the player P and are transmitted to a cloud server 4 via the server transmission/reception unit 68. At this time, the acceleration data and the angular velocity data of the left wrist P1 at the time of the simulated swing motion of the player P received from the wristwatch type terminal 1 are also transmitted to the cloud server 4 via the server transmission/reception unit 68.

The GPS receiving unit 63 constitutes a position measuring unit that acquires a current position of the mobile terminal 2 and wirelessly receives radio waves from a plurality of artificial satellites 32 to measure a three-dimensional position (longitude, latitude and altitude) of the mobile terminal 2 and send the position information to the control means 45. A position detecting device other than the GPS receiving unit 63 may be used as long as it can detect the current position of the mobile terminal 2. In addition, an atomic clock is mounted on the artificial satellite 32. An extremely accurate time signal wave is transmitted from the artificial satellite 32 at a specific frequency, and a time axis of the mobile terminal 2 is defined by receiving this by the GPS receiving unit 63. As described above, since the wristwatch type terminal 1 also receives the time signal wave from the artificial satellite 32 and the time axis is defined, by using the radio waves received from the artificial satellite 32, the time axes of the wristwatch type terminal 1 and the mobile terminal 2 are synchronized.

The transmission/reception unit 47 enables bidirectional communication between the wristwatch type terminal 1 and the mobile terminal 2 and between the mobile terminal 2 and the six-axis sensor unit 10 via a wired or wireless short-range communication means. Therefore, the mobile terminal 2 can send and receive data including various information to and from the wristwatch type terminal 1, the 6-axis sensor unit 10, and the like.

The storage unit 65 is configured by using various storage devices such as a magnetic hard disk device and a semiconductor storage device and can write and read various information such as actual play data and simulated play data acquired from the wristwatch type terminal 1, the mobile terminal 2 and the 6-axis sensor unit 10, respectively, the flight distance information and the corrected flight distance information acquired from the wristwatch type terminal 1 and various analysis information obtained from the actual play data, the simulated play data, the flight distance information and corrected flight distance information in addition to the position information of the mobile terminal 2 received by the GPS receiving unit 63.

The display unit 12 is composed of a liquid crystal module and a liquid crystal panel exposed on a front surface of a main body of the mobile terminal 2 and as is well known, these liquid crystal module and liquid crystal panel display a large number of sub-pixels in a dot matrix arranged in a grid pattern.

The operation unit 13 receives the operation by the player P and sends an electrical operation signal to the control means 45. In the mobile terminal 2 of the present embodiment, the display unit 12 is a touch panel and the surface portion of the display unit 12 functions as the operation unit 13.

Similar to the notification unit 26 provided in the wristwatch type terminal 1 described above, the notification unit 66 functions as an output unit when presenting swing information at the best flight distance, which will be described later, by voice or vibration. The output unit is composed of, for example, a speaker that outputs sound and/or a vibrator that generates vibration.

The oscillator 67 sends a clock signal generated at a predetermined cycle to the control means 15, and is composed of, for example, a silicon oscillator, a ceramic oscillator, a crystal oscillator, or the like. Further, by forming the silicon oscillator to be an oscillation circuit on the same silicon chip as the control means 61 to be a microcomputer, the oscillator 67 can be incorporated in an extremely small size and at low cost.

The server transmission/reception unit 68 enables bidirectional communication between the cloud server 4 as a server device and the mobile terminal 2 via the long-distance communication means 3 shown in FIG. 1. Therefore, the mobile terminal 2 can send and receive data including various information to and from the cloud server 4.

The control means 61 includes the swing measurement control unit 73 in which the waveform data of the acceleration and the angular velocity from the third inertial measurement unit 62 are taken in at intervals determined by the clock signal from the oscillator 67 and the motion of the waist P3 during the swing and the simulated swing of the player P is measured. The swing measurement control unit 73 receives the waveform data of the acceleration and the angular velocity from the third inertial measurement unit 62 and stores the actual play data and the simulated play data in which the time information from a clock unit 74 is added to the waveform data in the storage unit 65. The clock unit 74 provided in the control means 61 counts the time as the mobile terminal 2 based on the clock signal from the oscillator 67 and here, the clock unit 74 adds a set fixed time interval regardless of, for example, the start time of the waveform data, the start and end times of the waveform data, and the start and end of the waveform data as the time information to be added to the waveform data of the acceleration and the angular velocity from the third inertial measurement unit 62. Alternatively, the time counted by the clock unit 74 may be added each time the waveform data of the acceleration or the angular velocity is acquired from the third inertial measurement unit 62. The clock unit 74 here is provided in the third inertial measurement unit 62 as a first clock unit for counting the time in the third inertial measurement unit 62 of the mobile terminal 2, separately from the time in the first inertial measurement unit 16 of the wristwatch type terminal 1 and the time in the second inertial measurement unit 46 of the 6-axis sensor unit 10. In addition, the clock unit 74 is provided in an analysis unit 76 described later as a second clock unit that counts a reference time in the analysis unit 76.

The control means 61 further includes an analysis unit 76 that analyzes the relationship between a series of the swing motions by player P and flight distance based on the waveform data obtained by synchronizing the waveform data in actual play data and simulated play data captured from the clock-type terminal 3, mobile terminal 2, and 6-axis sensor unit 10, respectively and the flight distance information and the corrected flight distance information captured from the wristwatch type terminal 1. The analysis unit 76 includes the actual play data and the simulated play data in which the time information from the clock unit 43 is added to the waveform data from the first inertial measurement unit 16 and the play data in which the time information from the clock unit 57 is added to the waveform data from the second inertial measurement unit 46 as each data from multiple detection means, a time difference calculation unit 77, which corresponds to the measuring means for transmitting the actual play data and the simulated play data in which the time information from the clock unit 74 is added to the waveform data from the third inertial measurement unit 62, a data synchronization unit 78 and a data analysis unit 79, respectively.

The time difference calculation unit 77 calculates the difference between the reference time counted by the clock unit 74 and the time counted by the clock unit 43 of the wristwatch type terminal 1 or the clock unit 57 of the 6-axis sensor unit 10 and has a function that when a clock inquiry signal is sent from the transmission/reception unit 64 of the mobile terminal 2 to the clock unit 43 of the wristwatch type terminal 1 and the latest time data is received back from the clock unit 43, the difference between the received time and the latest time counted by the clock unit 74 of the mobile terminal 2 is calculated and further, when an inquiry signal is sent from the transmission/reception unit 64 of the mobile terminal 2 to the clock unit 57 of the 6-axis sensor unit 10 and the latest time data is received back from the clock unit 57, the difference between the received time and the latest time counted by the clock unit 74 of the mobile terminal 2 is calculated. The timing at which the time difference calculation unit 77 sends the inquiry signal is not particularly limited. Further, in the present embodiment, since the clock unit 74 of the third inertial measurement unit 62 counts the reference time itself, it is not necessary for the time difference calculation unit 77 to calculate the time difference with respect to the clock unit 74 of the third inertial measurement unit 62, and the configuration can be simplified.

The data synchronization unit 78 has a function that for example, every time the player P swings the golf club 7 and finishes hitting the ball 8, the operation unit 13 of the mobile terminal 2 instructs the synchronization of the actual play data, and the instruction signal for acquiring the actual play data is sent to the swing measurement control unit 38 of the wristwatch type terminal 1 and the swing measurement control unit 56 of the six-axis sensor unit 10, and when the actual play data stored in the storage unit 23 of the wristwatch type terminal 1 and the actual play data stored in the storage unit 48 of the 6-axis sensor unit 10 are taken in, respectively, these are stored in the storage unit 65 together with the actual play data obtained by adding the time information from the clock unit 74 to the waveform data of the acceleration and the angular velocity from the third inertial measurement unit 62 by the swing measurement control unit 73, and after that, based on the time difference calculated by the time difference calculation unit 77, the play data stored in the storage unit 65 are synchronized with each other.

The timing at which the data synchronization unit 78 captures the actual play data from the wristwatch type terminal 1 or the six-axis sensor unit 10 is not particularly limited. For example, when an operation for instructing synchronization of the actual play data is performed from the operation unit 13 of the mobile terminal 2, only the actual play data from the wristwatch type terminal 1 for which communication with the mobile terminal 2 has already been established may be taken in. Apart from that, when the communication is established between the six-axis sensor unit 10 and the mobile terminal 2, the actual play data from the six-axis sensor unit 10 may be automatically captured without performing the operation from the operation terminal 4. Alternatively, when the communication is established between the six-axis sensor unit 10 and the mobile terminal 2, not only the 6-axis sensor unit 10 but also the wristwatch type terminal 1 may be configured to automatically capture the actual play data without operating from the mobile terminal 2.

The data analysis unit 79 analyzes the relationship between the swing motion of the player P and the flight distance based on the acceleration and the angular velocity of the left wrist P1 of the player P measured by the first inertial measurement unit 16, the acceleration and the angular velocity of the back P2 of the player P measured by the second inertial measurement unit 46, the acceleration and the angular velocity of the waist P3 of the player P measured by the third inertial measurement unit 62, the flight distance of the ball 8 calculated by the flight distance calculation unit 37 and the corrected flight distance calculated by the corrected flight distance calculation unit 39.

The analysis result by the data analysis unit 79 is transmitted from the server transmission/reception unit 68 to the cloud server 4 as the actual swing measurement data obtained by measuring and quantifying the swing motion during play of the player P. That is, the data analysis unit 79 corresponds to a measurement data providing unit that sends the actual swing measurement data of the player P to the cloud server 4.

As described above, the time axes of the first inertial measurement unit 16 of the wristwatch type terminal 1, the second inertial measurement unit 46 of the six-axis sensor unit 10 and the third inertial measurement unit 62 of the mobile terminal 2 are synchronized. When the player P performs a series of the swing motions and simulated swing motions, the actual play data and the simulated play data of the left wrist P1 in which the time information from the clock unit 43 is added to the waveform data of the three-axis acceleration and the three-axis angular velocity measured by the first inertial measurement unit 16, the actual play data of the back P2 in which the time information from the clock unit 57 is added to the waveform data of the three-axis acceleration and the three-axis angular velocity measured by the second inertia measuring unit 46, and the actual play data and the simulated play data of the waist P3 obtained by adding the time information from the clock unit 74 to the waveform data of the three-axis acceleration and the three-axis angular velocity measured by the third inertia measuring unit 62 are stored in the storage unit 65 by the data synchronization unit 78. The time difference calculation unit 77 calculates the difference between the time counted by the clock unit 74 and the time counted by the clock unit 43 and the clock unit 57, respectively so that the waveform data of the acceleration and the angular velocity included in the play data of the left wrist P1, the back P2 and the waist P3 are synchronized with each other.

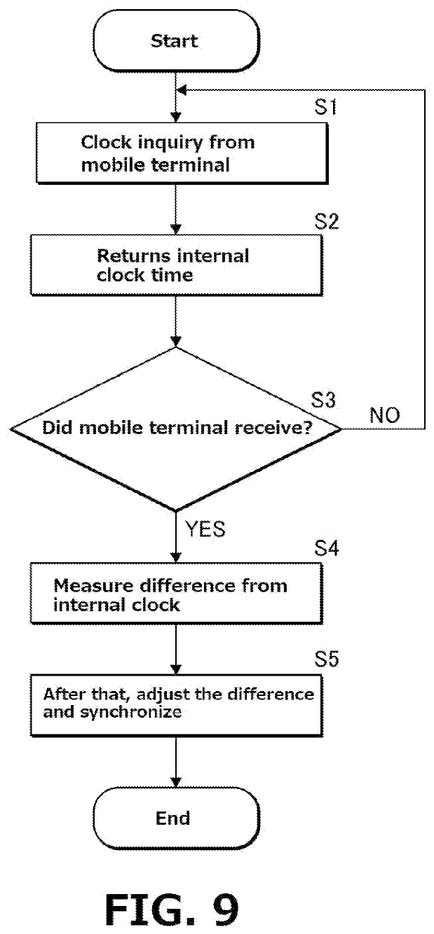

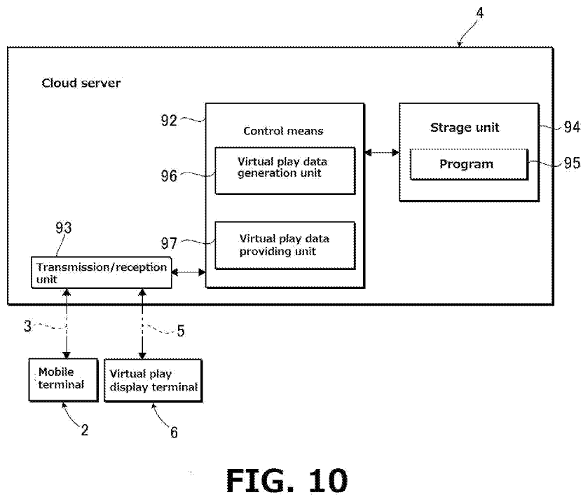

FIG. 9 shows an example of a suitable procedure for data synchronization by the time difference calculation unit 77 and the data synchronization unit 78. In the figure, in step S1, in order to inquire the clock from the mobile terminal 2, the time difference calculation unit 77 of the mobile terminal 2 sends the clock inquiry signal toward the wristwatch type terminal 1 and the six-axis sensor unit 10. The clock inquiry signal may be transmitted to the wristwatch type terminal 1 and the six-axis sensor unit 10 all at once or may be transmitted to each at different timings.

In response to this, in step S2, the time counted by the internal clock from the wristwatch type terminal 1 or the six-axis sensor unit 10 is returned to the mobile terminal 2. When the clock unit 43 of the wristwatch type terminal 1 receives the clock inquiry signal, the latest time data counted by the clock unit 43 is transmitted back from the transmission/reception unit 22 to the mobile terminal 2. Similarly, when the clock unit 57 of the six-axis sensor unit 10 receives the clock inquiry signal, the latest time data counted by the clock unit 57 is transmitted back from the transmission/reception unit 47 to the mobile terminal 2.

In step S3, it is determined whether or not the mobile terminal 2 has received the latest time data. When the transmission/reception unit 22 of the mobile terminal 2 receives the latest time data from the wristwatch type terminal 1 or the six-axis sensor unit 10, the process proceeds to the next step S4, and the time difference calculation unit 77 measures the difference between the received latest time data and the latest time counted by the clock unit 74, which is an internal clock. In step S4, the difference between the latest time counted by the clock unit 43 of the wristwatch type terminal 1 and the difference between the latest time counted by the clock unit 57 of the six-axis sensor unit 10 are calculated for the latest time counted by the clock unit 74 of the mobile terminal 2. In the case where the mobile terminal 2 cannot receive the latest time data from the wristwatch type terminal 1 or the six-axis sensor unit 10 within a certain period of time in step S3, the process returns to step S1 and the clock inquiry signal is transmitted again.

In this way, when the difference is calculated by the time difference calculation unit 77 in step S4, after that, the data synchronization unit 78 adjusts the temporal difference with the waveform data measured by the third inertial measurement unit 62 of the mobile terminal 2 in addition to the waveform data measured by the first inertial measurement unit 16 of the wristwatch type terminal 1 and the waveform data measured by the second inertial measurement unit 46 of the six-axis sensor unit 10. Therefore, for example, as in the case of the six-axis sensor unit 10, if the second inertial measuring unit 46 serving as the detection means is provided with only the clock unit 57 serving as the first clock unit, the waveform data measured by the second inertial measurement unit 46 can be easily synchronized with the waveform data measured by the first inertial measurement unit 16 or the third inertial measurement unit 62, which are other detection means even if an expensive GPS receiver and its power supply that receive the time signal wave from the artificial satellite 32 do not be incorporated.

As shown in FIG. 1, a virtual play display terminal 6 includes a display unit 86 and an operation unit 87, similar to a general PC or mobile terminal, but a converted ball hitting information described later sent from the cloud server 4 to a virtual play display terminal 6 is displayed on the display unit 86 of the virtual play display terminal 6.

FIG. 19 shows main components of the cloud server 4 which is a server device. In the figure, the cloud server 4 is configured to be connectable to a network such as the Internet as communication means 3 and 5, and includes a control means 92, a transmission/reception unit 93 and a storage unit 94.

The control means 92 includes a CPU (Central Processing Unit) and controls the entire cloud server 4 based on a program 95 stored in the storage unit 94. When the CPU executes arithmetic processing according to the program 95, each function of the cloud server 4 is realized. In particular, in the present embodiment, in order to make the control means 92 function as a virtual play data generation unit 96 and a virtual play data transfer unit 98, a virtual play data calculation program that cooperates with the swing analysis program described above is incorporated in the program 95. Then, the virtual play system is realized by executing these swing analysis programs and the virtual play data calculation programs by the control means 15, 45, 61, 92 as a computer.

The transmission/reception unit 93 enables bidirectional communication between the cloud server 4 and the mobile terminal 2 via the communication means 3, and further, bidirectional communication between the cloud server 4 and the virtual play display terminal 6 is enabled via the communication means 5. As described above, the mobile terminal 2 of the player P and the wristwatch type terminal 1 are also capable of bidirectional communication, and the cloud server 4 can send and receive various information not only to the mobile terminal 2 but also to the wristwatch type terminal 1 and the like. In FIG. 19, only one mobile terminal 2 is connected to the transmission/reception unit 93 of the cloud server 4, but practically, one or more mobile terminals 2 of a large number of other players P can also be connected.

The storage unit 94 is configured by using various storage devices such as a magnetic hard disk device and a semiconductor storage device and can write and read the swing measurement data and the like converted into a numerical UI (user interface) by an advice information generation unit 96 described later. In the virtual play system, it is preferable that the cloud server 4 acquires the actual swing measurement data when the player P actually swings during the actual play at the course and the simulated swing measurement data when the simulated swing is performed during the simulated play from the data analysis unit 79 of the mobile terminal 2 in real time and stores the data in the storage unit 94.

The virtual play data generation unit 96 converts the simulated swing measurement data from the data analysis unit 79 of the mobile terminal 2 into a numerical UI and stores it in the storage unit 94. Further, the virtual play data generation unit 96 has an artificial intelligence function using a multi-layered neural network (not shown). When the simulated swing measurement data read from the data analysis unit 79 of the mobile terminal 2 or from the storage unit 94 is input to the input layer of this neural network, the virtual play data generation unit 96 generates and outputs the virtual play data (texts, icons, figures, etc.) relating to the trajectory, flight distance, and the like of the ball 8 when player P holds the golf club 7 and hits the ball 8 by performing the same motion as the simulated swing motion. The type of neural network used by the virtual play data generation unit 96 to generate virtual play data is not particularly limited.

The virtual play data providing unit 97 transmits the virtual play data of the player P generated and output by the virtual play data generating unit 96 from the transmitting/receiving unit 93 to the virtual play display terminal 6 owned by the player P via the communication means 5.

Next, in order to perform the simulated play of the above configuration, it is necessary to accumulate the swing measurement data of the player P in advance. Therefore, every time the player P swings the golf club 7 during the actual round at the golf course, the waveform data of the acceleration and the angular velocity of the left wrist P1 measured by the first inertial measurement unit 16 of the wristwatch type terminal 1, the waveform data of the acceleration and the angular velocity of the waist P3 measured by the third inertial measurement unit 62 of the mobile terminal 2, and more preferably, the waveform data of the acceleration and the angular velocity of the back P2 measured by the second inertial measurement unit 46 of the six-axis sensor unit 10 are taken into the control means 61 of the mobile terminal 2, respectively and each waveform data synchronized on the time axis by the data synchronization unit 78 is stored in the storage unit 65 by the data analysis unit 79. Further, a fairway keep rate of the player P's past swing motion and a ratio of each ball direction of the hit ball (hook rate, slice rate, fade rate, draw rate, straight rate, etc.) are also stored and stored in the storage unit 65.

Further, the player P inputs the number of the golf club 7 from the sound collection unit 21 or the operation unit 21 of the wristwatch type terminal 1 for each hit in which the golf club 7 is swung and the ball 8 is thrown. As a result, the flight distance calculation unit 37 and the corrected flight distance calculation unit 39 of the wristwatch type terminal 1 capture the position information measured by the GPS receiving unit 17, the atmospheric pressure information measured by the atmospheric pressure measurement unit 18, the temperature information measured by the temperature measurement unit 19 and the altitude information measured by the altitude measurement unit 20, and the display unit 24 of the wristwatch type terminal 1 displays an average flight distance for each golf club 7 considering the height difference, the atmospheric temperature and the atmospheric pressure, etc. The flight distance and corrected flight distance data for each hit calculated by the flight distance calculation unit 37 and the corrected flight distance calculation unit 39 are also transmitted to the mobile terminal 2, and in response to this, the data analysis unit 79 associates each waveform data synchronized on the time axis by the data synchronization unit 78 described above with the flight distance and corrected flight distance data transmitted from the mobile terminal 2, and stores these data in the storage unit 65 as the swing measurement data of the player P, which is the analysis result by the data analysis unit 79.

Further, the analysis result by the data analysis unit 79, that is, the actual swing measurement data and the simulated swing measurement data of the player P are transmitted from the server transmission/reception unit 68 to the cloud server 4 via the communication means 3. The simulated play data generation unit 96 of the cloud server 4 that has received this in the transmission/reception unit 93 converts the actual swing measurement data and the simulated swing measurement data of the player P into a numerical UI and stores them in the storage unit 94.

Next, the operation of the simulated play having the above configuration will be described in detail. In this embodiment, the virtual play system is applied to a health promotion type golf game.

First, the player P operates the virtual play display terminal 6, reads out the golf course data stored in the cloud server 4, and selects the golf course 88 (see FIG. 1) to play. The selected golf course 88, the player icon 89 (see FIG. 3) displaying the operation information of the player P, and the ball icon 90 (see FIG. 1) are displayed on the display unit 86 of the virtual play display terminal 6. The player icon 89 displays the position of the player P on the golf course 88, and the ball icon 90 displays the position of the ball on the golf course 88. When the operation for starting play is performed by the operation unit 87 of the virtual play display terminal 6, the game is started and the game can be played from the first hole. The operation at the start of play may be performed by the mobile terminal 2.

The display unit 86 of the virtual play display terminal 6 displays a yard display of the remaining distance to the green of the golf course 88 and the specified number of strokes of each hole. In addition, the type and flight distance of the golf club 7 used for the play are displayed, and the trajectory of the play progress can be visually confirmed. The information displayed on the display unit 87 of the virtual play display terminal 6 may be displayed on the wristwatch type terminal 1 or the mobile terminal 2 at the same time.

When the player P operates the operation unit 87 of the virtual play display terminal 6 to specify the number of the golf club 7 to be used and the direction of hitting the ball, and then performs a simulated swing motion, the simulated swing measurement data detected by the wristwatch type terminal 1 and the mobile terminal 2 is transmitted to the cloud server 4. The cloud server 4 reads the past accumulated data of the player P stored in the storage unit 94, compares the accumulated data with the received simulated swing measurement data, and calculates the virtual play data. Then, the ball icon 90 is moved and displayed at the arrival point based on the virtual play data. The number of the golf club 7 may be input by voice by the sound collection unit 21 of the wristwatch type terminal 1. Further, the player P actually turns his/her body while looking at the direction of the player icon 89 on the golf course 88 displayed on the display unit 24 of the wristwatch type terminal 1 do that the direction of the player icon 89 may be adjusted to specify the direction in which the ball is hit.

The wristwatch type terminal 1 and the mobile terminal 2 have a step count measurement function and a travel distance measurement function, and after the simulated swing, when the player P steps on the spot or actually walks or runs, the wristwatch type terminal 1 and the mobile terminal 2 detect the simulated movement motion of the player P, and the simulated movement motion information is transmitted to the cloud server 4. The cloud server 4 calculates movement amount information for moving the player icon 89 from the simulated movement operation information and sends the movement amount information to the virtual play display terminal 6. The virtual play display terminal 6 moves and displays the player icon 89 in the direction of the arrival point of the ball icon 90 based on the received movement amount information. That is, the player icon 89 can be moved by the simulated movement operation of the player P. In the present embodiment, the player icon 89 is moved by a simulated movement operation, but if you want to proceed with the play only by the simulated swing motion, you may set to automatically move the player icon 89 to the reaching point of the ball icon 90 after the simulated swing motion is completed. After moving the player icon 89 to the reaching point of the ball icon 90, the second shot can be hit by designating the number of the golf club 7 to be used and the direction in which the ball 8 is hit and performing a simulated swing motion. After that, the 3rd shot, the 4th shot, . . . , the 2nd hole to the 18th hole can be simulated and played in the same manner. In addition, this health promotion type golf game can be interrupted in the middle of play, and it is also possible to store the play information at the time of interruption in the storage unit 94 of the cloud server 4 or the storage unit 91 (see FIG. 1) included in the virtual play display terminal 6, and to resume the play later. The storage unit 91 can store the same data and information as the data and information stored in the storage unit 94 of the cloud server 4.

In the above, the player P plays alone, but a plurality of players P may play at the same time. In that case, the wristwatch type terminal 1 and the mobile terminal 2 of each player P are connected to the cloud server 4 via the communication means 3, and the cloud server 4 and the virtual play display terminal 6 of each player P are connected via the communication means 5. Each virtual play display terminal 6 can display the name of each player P, the yard display of the remaining distance to the green, and the trajectory of each player P's play progress.

Further, the player P can display his/her own simulated play history and the past simulated play history of another player P on the virtual play display terminal 6 and play against the simulated play history. In this case, the history information of the simulated play stored in the storage unit 94 of the cloud server 4 is read out and displayed on the virtual play display terminal 6.

As described above, the virtual play system of the present embodiment is composed of the mobile terminal 2 worn by player P, the virtual play display terminal 6 provided with a display unit 86 and the cloud server 4 capable of communicating with mobile terminal 2 and virtual play display terminal 6. The mobile terminal 2 includes a virtual play data providing unit 97 that transmits the actual swing measurement data obtained by measuring and quantifying the actual motion of player P during play and the simulated swing measurement data obtained by measuring and quantifying the motion of player P during simulated play to the cloud server 4, and the cloud server 4 includes the virtual play data generation unit 96 that calculates the virtual play data based on the actual swing measurement data and the simulated swing measurement data, and the virtual play display terminal 6 displays virtual play data.

This makes it possible to calculate virtual play data based on the actual play measurement data of swing motion during a round in which the player P is actually playing at a golf course and the simulated play measurement data of simulated swing motion performed by player P without holding the golf club 7. Then, by displaying the virtual play data on the virtual play display terminal 6, the player P can play the virtual golf game indoors or the like. At this time, since the player P performs the simulated swing, a stepping motion, and the like, health is promoted by appropriate exercise in the room or the like.

Further, in the virtual play system of the present embodiment, the cloud server 4 can communicate with the mobile terminal 2 and the virtual play display terminal 6 of a plurality of players P, and the virtual play display terminal 6 can display virtual play data of the plurality of players P.

As a result, the virtual play data of the plurality of players P can be displayed on the virtual play display terminal 6 at the same time by performing the simulated play by the plurality of players P at the same time. Therefore, the plurality of players P in different places can play the virtual golf game on the same golf course 88.

Further, in the virtual play system of the present embodiment, the first measurement data is obtained by measuring and quantifying the swing motion when the player P holds the golf club 7 and actually hits the ball 8, the second measurement data is obtained by measuring and quantifying the simulated swing motion performed by the player P without holding the golf club 7, and the virtual play data is the trajectory data of the ball 8 when it is assumed that the player P holds the golf club 7 and performs the same motion as the simulated swing motion to hit the ball 8.

As a result, the virtual play data of the player P is calculated from the actual play measurement data and the simulated play measurement data of the player P, and the virtual golf game can be played by displaying the trajectory data of the ball 8 on the golf course 88 on the virtual play display terminal 6.

The present invention is not limited to the above embodiment, and various modifications can be made within the scope of the gist of the present invention. The virtual play system is not limited to the golf player P described above and can be applied to various sports by using baseball, tennis, soccer, and various other sports players as objects to be measured.

### EXPLANATION OF REFERENCE NUMERAL

2: Mobile terminal (player terminal)
4: Cloud server (server device)
6: Virtual play display terminal
7: Golf club
8: Ball
79: Data analysis unit (measurement data providing unit)
86: Display unit
96: Virtual play data generation unit
P: Player

1. A virtual play system comprising:
a player terminal worn by a player,
a display terminal provided with a display unit, and
a server device capable of communicating with the player terminal and the display terminal,
wherein the player terminal includes a measurement data providing unit that transmits first measurement data obtained by measuring and quantifying motion of the player during actual play and second measurement data obtained by measuring and quantifying motion of the player during simulated play to the server device,
wherein the server device includes a virtual play data generation unit that calculates virtual play data based on the first measurement data and the second measurement data, and
wherein the display terminal displays the virtual play data.

2. The virtual play system according to claim 1, wherein the server device is configured to be capable of communicating with the player terminal and the display terminal of a plurality of players, and
wherein the display terminal is configured to be capable of displaying the virtual play data of the plurality of players.

3. The virtual play system according to claim 1, wherein the first measurement data is obtained by measuring and quantifying a swing motion when the player actually hits a ball with a golf club,
wherein the second measurement data is obtained by measuring and quantifying a simulated swing motion performed by the player without holding the golf club, and
wherein the virtual play data may be trajectory data of the ball when it is assumed that the player holds the golf club and performs the same operation as the simulated swing operation to hit the ball.

4. The virtual play system according to 2, wherein the first measurement data is obtained by measuring and quantifying a swing motion when the player actually hits a ball with a golf club,
wherein the second measurement data is obtained by measuring and quantifying a simulated swing motion performed by the player without holding the golf club, and
wherein the virtual play data may be trajectory data of the ball when it is assumed that the player holds the golf club and performs the same operation as the simulated swing operation to hit the ball.
